(19) United States
(12) Patent Application Publication
(10) Pub. No.: US 2014/0168931 A1
(43) Pub. Date: Jun. 19, 2014

(54) Versatile light reflecting system for photography

(71) Applicant: John Melvin Snow, Ft. Myers, FL (US)

(72) Inventor: John Melvin Snow, Ft. Myers, FL (US)

(21) Appl. No.: 13/694,614

(22) Filed: Dec. 18, 2012

(51) Int. Cl. G03B 15/06

(52) U.S. Cl. CPC G03B 15/06
USPC 362/12

(57) ABSTRACT

A light reflecting system for photography including a floor mounted stanchion that supports an element support having a forwardly facing strobe light therein. A support plate is mounted on the support element having a central opening therein to allow the light created by the strobe light to be reflected from an umbrella type light reflecting screen which is forwardly mounted on to the support plate. The support plate additionally has a multiple of forwardly facing incandescent light bulbs. The Incandescent light bulbs can change their intensity of light reflected from the umbrella type by of switches associated with each of the light bulbs whereby more or less light bulbs can be activated. The rear surface of the support plate has an electrical socket placed therein to supply electricity to each of the light bulbs.

### BACKGROUND OF THE INVENTION

There are many systems that supply lighting when photographs are being taken in a Photography studio. One such system is mounted into the camera that provides instant light flashes when a picture is taken. In Photography studios there are specially designed lighting systems. One such system is mounted on a tri-pod and has a supporting element at its top that has a forwardly mounted strobe light attached thereto. A support plate mounted on the element further has means thereon to mount an umbrella type reflector. This reflector will magnify and direct the light coming from the strobe light to the object to be photographed. A strobe light has disadvantages in that the instant flash of light causes the person or persons to be photographed to instantly shut their eyes. When animals are to be photographed they get very skittish when the light flashes.

On the other hand, the photographer has a disadvantage in that only he/she sees the object to be photographed through the lens and without any light and, therefore, cannot ascertain the final outcome of the quality of the photograph after it has been developed.

### BRIEF DESCRIPTION OF THE INVENTION

The instant invention takes the above noted problems into account by adding an incandescent light source to the known system. The added light source is mounted adjacent or in line with the strobe light. The added light source consists of a multiple of incandescent light bulbs which are mounted on a support plate that supports an umbrella type reflector screen. This renders the earlier described photo reflecting light system considerably more versatile since the photographer has the choice of using the strobe light or the incandescent light source. As mentioned above, there are a multiple of forwardly mounted incandescent light bulbs and the photographer has a choice as to how many light bulbs are to be used because each of the light bulbs has a switch associated therewith. It all depends on the subject to be photographed such as a group of people or a single person. This then would influence the intensity of the reflected light which is being reflected from the umbrella type reflector screen which surrounds the light source. On the other hand if a piece of art is to be photographed the photographer still has the choice of using the strobe light which would be much more suitable for this kind of photography.

### BRIEF DESCRIPTION OF THE DRAWINGS

FIG. 1 is a perspective and blown-up of view of a known light reflecting system;

FIG. 2 is a front view of a support plate that supports the reflector screen;

FIG. 3 is rear view of the support plate of FIG. 2;

FIG. 4 is a side vie of the reflector plate of FIG. 2.

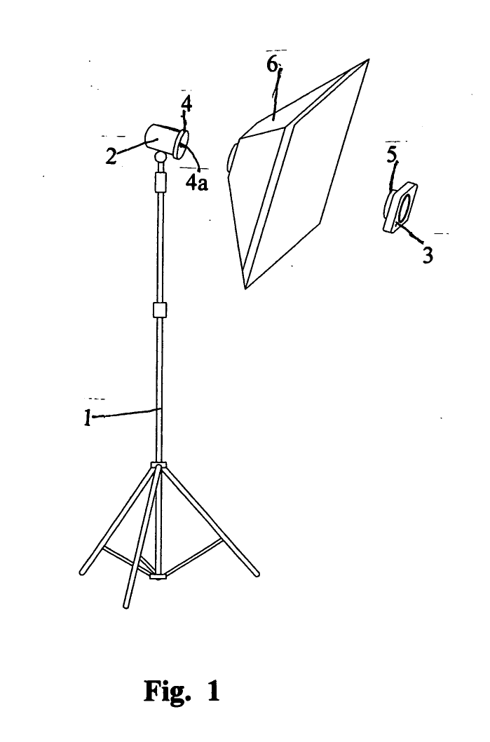

In FIG. 1 there is shown a tri-pod or support stanchion 1 that supports a support element 2 at its top. This support element 2 has a center opening through which the well known strobe light will protrude. The support element also shows a circular retaining ring 4 which will engage the circular retaining ring of the support plate 3. The support plate 3 with its retaining ring 5 will engage the retaining ring 4 of the support element 2 and will be fastened thereto. The reflector umbrella type screen will be mounted to front of the support plate. The reflector screen is normally made of a flaccid material having an outwardly directed reflection material. The reflector screen is normally mounted to the support plate 3 by at least four staves that engage tunnels in the four corners of the square configured screen.

The support plate 3 is configured such that when mounted on the support element 2, the center opening for the strobe bulb will protrude there through and will still be available if so desired.

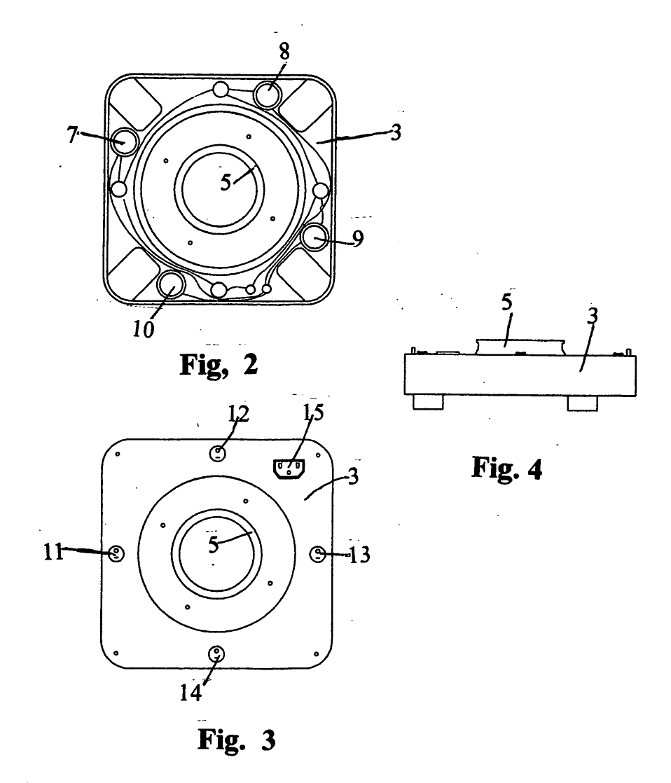

FIG. 2 is a more detailed description of the instant invention. In FIG. 2 there is shown a front view of the support plate 3 which will support at least four sockets 7-10 which will receive incandescent light bulbs. Of course, any other number more or less can change the visual appearance of the front of the support plate 3. Again the mounting ring 5 is shown which explained above will fasten the support plate 3 to the support element 2 and, of course, thereby the umbrella type reflector screen. The support plate 3 also has at its rear surface mounted thereon an electrical socket 15 which will receive its own electricity by way of an extension cord besides the requirement for electricity of the strobe light

FIG. 3 is a rear view of the support plate 3 which again shows the connector ring 5. Each of the front sockets has a light switch at the rear surface of the support plate 3. Each of the switches is shown at 11-14. Of course as the number of the front incandescent light bulbs changes, so will the number of switches. The use of the switches enables the photographer to change the intensity if the light reflector screen by switching on more or less of the incandescent lights depending on the subject to be photographed.

FIG. 4 is a side view of the support plate 3. The connector ring 5 is shown again. As explained above the connector rings 5 and 4a , when connected support the plate 3.

What I claim is:

1. A versatile light reflecting system for photography consisting of a floor supported stanchion, said stanchion having at its top an element support, said element support having mounted therein a forwardly facing strobe light, means for connecting a support plate to said element support, said support plate supporting an umbrella type light reflector, the improvement comprising: said support having mounted thereon a plurality of forwardly facing light bulbs, said light bulbs when lit will reflect the created light from said umbrella type reflector screen.

2. The light reflecting system of claim 1 having means for changing the intensity of the light generated by said light bulbs.

3. The light reflecting system of claim 2, said means for changing the intensity is a light switch associated with each of said light bulbs.

4. The light reflecting system of claim 1 wherein said light bulbs are incandescent light bulbs.

5. The light reflecting system of claim 1 including an electrical socket mounted at a read surface of said support plate to provide said multiple of lights with electricity.
